(19) United States
(12) Patent Application Publication
(10) Pub. No.: US 2006/0166695 A1
(43) Pub. Date: Jul. 27, 2006

(54) Automatic switching between mobile radios

(76) Inventor: Rolf Morich, Berlin (DE)

Correspondence Address: BELL, BOYD & LLOYD, LLC, P. O. BOX 1135, CHICAGO, IL, 60690-1135, US

(21) Appl. No.: 10/520,503

(22) PCT Filed: Jun. 27, 2003
(86) PCT No.: PCT/DE03/02214

§ 371 Date: Jan. 3, 2005

(30) Foreign Application Priority Data
Jul. 3, 2002 (DE) 102 30 617.6

(51) Int. Cl. H04M 1/00

(52) U.S. Cl. 455/550.1

(57) ABSTRACT

The present invention relates to a method for switching between a first mobile communication device and a second mobile communication device of a subscriber. The first and second mobile communication devices have a common telephone number and billing is carried out on the common account. Switching is carried out automatically with the aid of a signal between the first and second mobile communication devices transmitted via a wireless interface.

### BACKGROUND OF THE INVENTION

The present invention relates to switching with respect to use between two mobile radios for one subscriber. If a subscriber wishes to use a mobile radio in a mobile radio system such as GSM/GPRS or UMTS, the mobile radio or the terminal must be equipped with a so-called SIM (Subscriber Identity Module). This SIM authorizes the subscriber within the mobile radio system or in the network. If one subscriber is using two or more terminals, then the subscriber is authenticated in the network once again by the respective SIM for each terminal that is used. As such, for example, when one subscriber is using two terminals, he/she has two SIM cards with two different telephone numbers, which are billed by two different accounts. In order to simplify the use of two terminals for one subscriber in terms of billing and use, providers offer so-called twin cards. A twin card operates on the following principle: one and the same account is maintained for two SIM cards with one telephone number, and is passed to the respective terminal in the network via call diversion. In this case, the call diversions in the network are switched such that calls are handled on the most recently registered terminal. The second, unused terminal should always be switched off, for safety. If a subscriber wishes to change from a terminal which is equipped with a twin card to another terminal, then he/she must take care to ensure that the appliance which he/she currently wishes to use is the last which was registered in the mobile radio system or the network. This is highly inconvenient, in particular when he/she wishes to change over for only a short time interval. Accordingly, only manual switching between two terminals has been possible until now. The subscriber must ensure that the terminal which he/she wishes to use for communication at that time was the last to be registered in the network.

The present invention seeks to provide a method and a communications system by which it is possible to switch between mobile radios automatically.

### SUMMARY OF THE INVENTION

In an embodiment, a method is provided for switching from a first mobile communications appliance to a second mobile communications appliance for one subscriber, with the first and second mobile communications appliances having a common telephone number and being billed via a common account, and with the switching being carried out automatically via signaling between the first and second mobile communications appliances via a wire-free interface.

According to the present invention, switching from one terminal or mobile communications appliance to another in a network is activated automatically. In this case, a switching procedure is initiated automatically via signaling using a wire-free interface.

An interface based on short-distance radio technology is preferably used as the wire-free interface in this case.

It is further preferable in this case for the wire-free interface to be a Bluetooth interface.

When a mobile terminal or communications appliance with a Bluetooth interface comes within range of another mobile communications appliance, this is identified via the Bluetooth interface. In order that only authorized people are ensured automatic access to the second mobile communications appliance, an authentication procedure with respect to the subscriber is preferably provided. For example, a security mechanism which is integrated in the Bluetooth technology can be activated for this purpose.

In one preferred embodiment of the method according to the present invention, the authentication procedure is carried out by checking a subscriber PIN. In this case, the subscriber PIN is then stored in the appropriate terminal or mobile communications appliance. The terminal then may be accessed once again without any PIN check. Once a subscriber has been registered, an algorithm must monitor whether the mobile communications appliances are at different ranges. To do this, one mobile communications appliance transmits a so-called beacon at specific time intervals. The other mobile communications appliance responds to the beacon, and then waits for the next beacon. Since systems such as Bluetooth necessarily have mechanisms such as these by virtue of the system design, a so-called beacon channel for a so-called park mode can be used for monitoring in this case. If there is no response from the other mobile communications appliance, then the original mobile communications appliance is activated, and the system switches back to it.

An advantage of the present invention is that the proximity of the subscriber is identified via a wire-free, preferably short-distance radio, technology, and a change between the corresponding mobile communications appliances is signaled to the network by signaling. This allows automatic switching between two mobile communications appliances for a twin card system.

The present invention also covers a mobile radio system having at least one first and one second communications appliance of a subscriber, with the first and second mobile communications appliances having a common telephone number, being billed via a common account, and the first and second communications appliances each having a wire-free interface via which it is possible to switch automatically between the first and second communications appliances.

The wire-free interface is preferably an interface based on short-distance radio technology; in particular, a Bluetooth interface.

In one particularly preferred embodiment of the mobile radio system according to the present invention, a subscriber authentication procedure can be carried out.
As already described, this is preferably carried out a PIN check.
Additional features and advantages of the present invention are described in, and will be apparent from, the following Detailed Description of the Invention and the Figures.

### BRIEF DESCRIPTION OF THE FIGURES

FIG. 1 shows a schematic illustration of a procedure for one embodiment of a method according to the present invention.

### DETAILED DESCRIPTION OF THE INVENTION

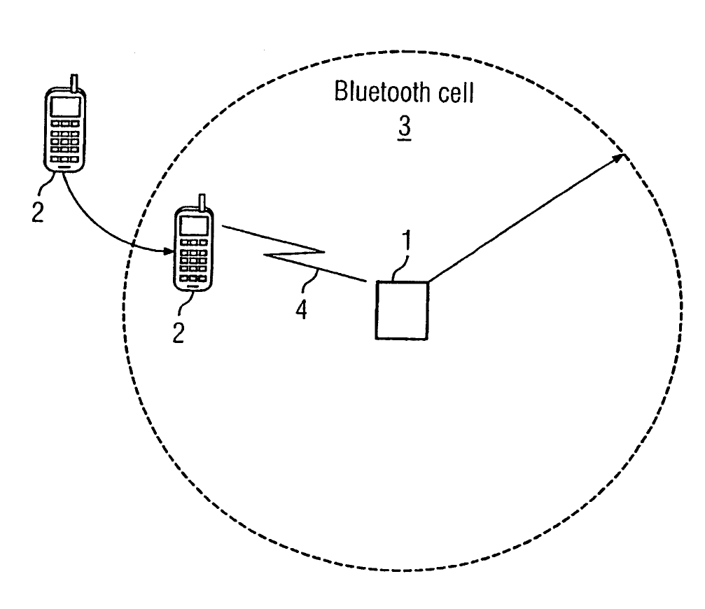

FIG. 1 shows an autocommunication system in the form of a GSM/GPRS communication module 1 and a mobile telephone 2, which are located within a mobile radio network. Both communications appliances 1, 2 are equipped with a twin card. The twin card is used primarily in the automobile field. In this case, the GSM/GPRS communication module 1 is installed in a car and is optimized to the environment in the car. If the subscriber also has a mobile telephone 2, he/she must use a twin card system. When the subscriber with the mobile telephone 2 comes within range of the Bluetooth cell 3 of the GSM/GPRS communication module 1, which is installed in the car, then the mobile telephone 2 is registered via a wire-free interface, particularly automatically via a Bluetooth interface 4, with the GSM/GPRS communication module 1. This registration also may be protected by a PIN input, in order to ensure authentication. Once the mobile telephone 2 has successfully registered with the GSM/GPRS communication module 1 in the car, then the GSM/GPRS communication module 1 registers the change in the active state with the mobile radio network. A change in the active state from the mobile telephone 2 to the GSM/GPRS communication module 1 is thus activated automatically upon entering the car. When the subscriber goes beyond the range of the Bluetooth cell 3 in the car, then the installed GSM/GPRS communication module 1 is deregistered after a timer has timed out, after a designated time interval, and the mobile telephone 2 is registered with the mobile radio network.

Although the present invention has been described with reference to specific embodiments, those of skill in the art will recognize that changes may be made thereto without departing from the spirit and scope of the present invention as set forth in the hereafter appended claims.

1-9. (canceled)

10. A method for automatically switching from a first mobile communications appliance to a second mobile communications appliance of a subscriber, wherein the first and second mobile communications appliances have a common telephone number and are billed via a common account, the method comprising:
providing a wire-free interface for the first and second mobile communications appliances; and
signaling between the first and second mobile communications appliances via the wire-free interface to effect the automatic switching.

11. A method for automatically switching from a first mobile communications appliance to a second mobile communications appliance as claimed in claim 10, wherein the wire-free interface is an interface based on short-distance radio technology.

12. A method for automatically switching from a first mobile communications appliance to a second mobile communications appliance as claimed in claim 11, wherein the wire-free interface is a Bluetooth interface.

13. A method for automatically switching from a first mobile communications appliance to a second mobile communications appliance as claimed in claim 10, further providing an authentication procedure relating to the subscriber.

14. A method for automatically switching from a first mobile communications appliance to a second mobile communications appliance as claimed in claim 13, wherein the authentication procedure is carried out by checking a subscriber PIN.

15. A mobile radio system, comprising:
a first communications appliance of the subscriber;
a second communications appliance of the subscriber, wherein the first and second mobile communications appliances have a common telephone number and are billed via a common account; and
a wire-free interface between the first and second communications appliances via which automatic switching between the first and second communications appliances may be effected.

16. A mobile radio system as claimed in claim 15, wherein the wire-free interface is an interface based on short-distanced radio technology.

17. A mobile radio system as claimed in claim 16, wherein the wire-free interface is a Bluetooth interface.

18. A mobile radio system as claimed in claim 15, wherein a subscriber authentication procedure may be carried out.

19. A mobile radio system as claimed in claim 18, wherein the subscriber authentication procedure may be carried out via a PIN check.
